(19) United States
(12) Patent Application Publication
(10) Pub. No.: US 2008/0237040 A1
(43) Pub. Date: Oct. 2, 2008

(54) TEST STRIP AND MONITORING DEVICE

(76) Inventor: Paul Wessel, Loretto, MN (US)

Correspondence Address: CROMPTON, SEAGER & TUFTE, LLC, 1221 NICOLLET AVENUE, SUITE 800, MINNEAPOLIS, MN, 55403-2420, US

(21) Appl. No.: 12/057,041

(22) Filed: Mar. 27, 2008

Related U.S. Application Data
(60) Provisional application No. 60/908,228, filed on Mar. 27, 2007.

(51) Int. Cl. G01N 27/26

(52) U.S. Cl. 204/403.02

(57) ABSTRACT

Test strips and monitoring devices for the electrochemical analysis of analytes are disclosed. An illustrative test strip may include first and second electrodes, offset relative to one another with respect to an insertion end of the test strip. The monitoring device may have a stop and electrical contacts configured to position the test strip such that the offset electrodes are in contact with the electrical contacts of the monitor. In some cases, the insertion end of the test strip and the stop of the monitoring device include one or more features to key the insertion end of the test strip with the stop. Also, one or more programmable devices may be provided on or in the test strip for providing information and/or calibration data to the monitoring device when inserted into the monitoring device. In some embodiments, a monitoring device may be provided that includes a removable Sharps container for storing used test strips.

This application claims the benefit of U.S. Provisional Application Ser. No. 60/908,228, filed Mar. 27, 2007, entitled, “TEST STRIP AND MONITORING DEVICE”.

### FIELD

The present invention relates generally to the field of health monitoring. More specifically, the present invention relates to test strips and monitoring devices for monitoring analytes including glucose.

### BACKGROUND

The impact of diabetes-related complications on the population represents a significant portion of healthcare costs worldwide. Blood glucose monitors are frequently employed by individuals suffering from diabetes, hypoglycemia and other blood disorders to determine the amount of glucose contained in the blood stream. Blood glucose monitors are typically used in conjunction with disposable test strips. During use, the user typically places a small blood sample on a designated sensing part of the test strip. The test strip is then inserted into a slot of the blood glucose monitor, and the blood glucose monitor “reads” a value that is related to the glucose concentration in the blood sample.

The test strips often include a substrate with a sensor disposed thereon or therein. The sensor is typically adapted to be sensitive to the analyte to be detected. Often, the test strips include electrodes that are connected to and extend away from the sensor toward an insertion end of the test strip that is ultimately inserted into the blood glucose monitor. During use, when the test strips are inserted into the blood glucose monitor, electrical contacts within the monitor engage the electrodes of the test strip, and electrically read a value from the sensor.

### SUMMARY

The present invention relates generally to test strips and corresponding monitoring devices for performing an electrochemical measurement of an analyte in a small volume of fluid.

### BRIEF DESCRIPTION OF THE DRAWINGS

FIG. 1 is a top view of an illustrative test strip in accordance with an illustrative embodiment of the present invention;

FIG. 2 is a partially exploded cross-sectional side view of the test strip of FIG. 1 taken along line 2-2;

FIG. 3 is a partial schematic cross-section side view showing the test strip of FIG. 1 inserted into a monitor device, wherein the monitor device includes offset electrical contacts for engaging the conductors of the test strip of FIG. 1;

FIG. 4 is a partial schematic cross-section side view showing the test strip of FIG. 1 inserted into a monitor device, wherein the monitor device includes non-offset electrical contacts for engaging the conductors of the test strip of FIG. 1;

FIG. 5 is a schematic diagram of an illustrative controller of FIGS. 3-4;

FIG. 6 is a schematic top view of another illustrative test strip that is inserted into a monitor device;

FIG. 7 is a schematic top view of yet another illustrative test strip that is inserted into a monitor device;

FIG. 8 is a schematic top view of another test strip that includes an illustrative programmable calibration code element disposed thereon or therein;

FIG. 9 is a schematic diagram of another illustrative controller that may be used in conjunction with the test strip of FIG. 8;

FIG. 10 is a top view of an illustrative test strip positioned in a monitoring device in accordance with another illustrative embodiment of the present invention;

FIG. 11 is a schematic cross-sectional side view of an illustrative embodiment of the test strip and monitoring device of FIG. 10 taken along line 11-11;

FIG. 12 is a schematic cross-sectional side view of another illustrative embodiment of the test strip and monitoring device of FIG. 10 taken along line 11-11;

FIG. 13 is a schematic view of an illustrative monitoring device with a sharps container; and

FIG. 14 is a schematic view of another illustrative monitoring device with a sharps container.

### DESCRIPTION

The following description should be read with reference to the drawings, in which like elements in different drawings are numbered in like fashion. The drawings depict several illustrative embodiments, and are not intended to limit the scope of the invention. While the devices, systems, and methods are frequently described herein with respect to blood glucose monitors, it should be understood that the devices, systems, and methods apply to detection and measurement of other analytes.

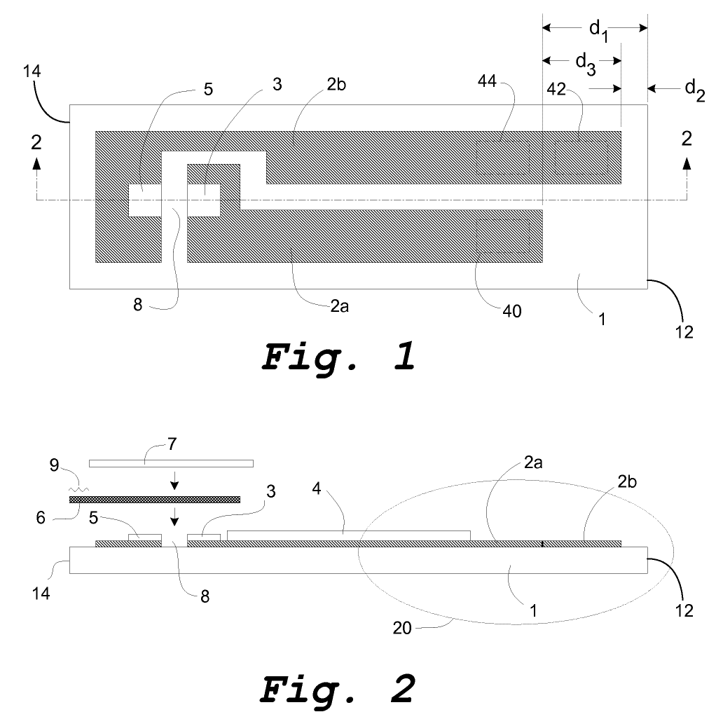

FIG. 1 is a top view of an illustrative test strip in accordance with an illustrative embodiment of the present invention. FIG. 2 is a partially exploded cross-sectional side view of the test strip of FIG. 1 taken along line 2-2. The illustrative test strip shown in FIGS. 1-2 includes a non-conducting substrate 1 and, deposited thereon or therein, a first conducting electrode 2a and a second conducting electrode 2b. The first conducting electrode 2a carries a reference electrode 3, and the second conducting electrode 2b carries a reagent element 5. In the illustrative embodiment, the first and second conducting electrodes 2a, 2b carry a spacer layer 4 (this and other components described below are not shown in FIG. 2, which is provided merely to show the electrical configuration). In some cases, a mesh material 6 is laid over the reference electrode 3, part of the spacer 4 and the reagent element 5. Tape 7 may then be provided over the mesh material 6, if desired.

The sensing area is shown at 8, and is defined between the respective parts of the reagent element 5 and the reference electrode 3. The mesh material 6 is shown not coextensive with the tape 7, thereby defining a sample application area 9. In use, a blood sample may be applied to sample application area 9. The blood sample may then be carried by the mesh material 6, so that it floods areas 3, 5 and 8. The presence of an analyte in the blood sample, such as glucose, can then be determined electrochemically by applying and sensing appropriate electrical signals at the first and second conducting electrodes 2a, 2b of the test strip.

Although not required, it is contemplated that the illustrative test strip may be constructed similar to that shown and described in U.S. Pat. Nos. 6,436,256 and 6,309,535, both issued to Williams et al., and both incorporated herein by reference. In the illustrative test strip of FIGS. 1-2, the conducting electrodes 2a and 2b do not both extends to the same distance from an insertion end 12 of the test strip. The insertion end 12 of the test strip is the end that is intended to be inserted into a monitoring device, and is typically opposite a sensor end 14, but this is not required in all embodiments. As shown, the first conducting electrode 2a terminates a first distance d₁ from the insertion end 12 of the test strip, and the second conducting electrode 2b terminates a second distance d₂ from the insertion end 12 of the test strip. In some cases, the first distance d₁ may be in the range of 0.5 mm-5.0 mm, and the second distance d₂ may be in the range of 2.5-10 mm, but it is contemplated that any other suitable dimension may be used, as desired. The distance that the first distance d₁ exceeds the second distance d₂ is represented by an offset distance d₃, which may be in the range from 1-7 mm, such as 2.7 mm, or any other suitable dimension as desired.

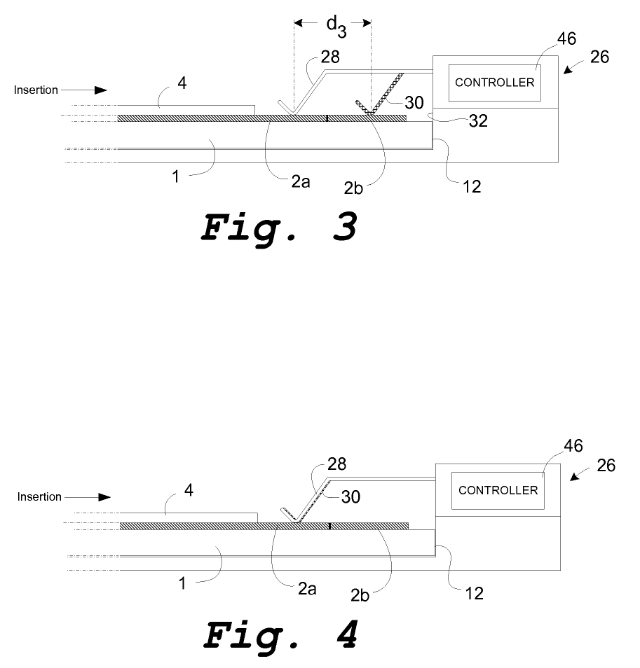

FIG. 3 is a partial schematic cross-section side view showing the test strip of FIG. 1 inserted into a monitor device 26, wherein the monitor device 26 includes electrical contacts 28 and 30 offset from one another for engaging the offset conducting electrodes 2a and 2b, respectively, of the test strip of FIG. 1. The monitoring device may have a controller 46 that is electrically connected to the electrical contacts 28 and 30 for interrogating the test strip via the electrical contacts 28 and 30.

The monitoring device 26 is only partially shown for clarity. It is contemplated that the monitoring device 26 may include other components, including a housing that has a slot therein for receiving the test strip. In some embodiments, the slot may be configured to allow only the insertion end 12 of the test strip to be inserted, but not the sensing end 14. The insertion and sending ends 12, 14 of the test strip may have different shapes with the shape of the insertion end 12 configured to fit within the slot in the monitoring device. The slot in the monitoring device may include tabs, stops, pins, or other structures that are configured to mate only with the insertion end 12 of the test strip. In some embodiments the insertion end of the test strip may be thinner than the sensing end 14.

In FIG. 3, the insertion end 12 of the test strip is shown inserted and placed against a stop 32 of the monitoring device 26. As the test strip is inserted, the electrical contacts 28 and 30 slide over the conducting electrodes 2a and 2b, respectively, of the test strip of FIG. 1, as shown. The electrical contacts 28 and 30 may provide a downward bias to maintain good electrical contact with the conducting electrodes 2a and 2b. In the illustrative embodiment, electrical contact 28 extends out further from the insertion end 12 of the test strip relative to electrical contact 30. In some cases, electrical contact 28 may extend out further from the insertion end 12 relative to electrical contact 30 by the distance d₃ (see FIG. 1), but when provided, it is contemplated that any other suitable offset distance may be used as desired. In the illustrative embodiment, electrical contact 28 may engage the first conducting electrode 2a in a region designated by phantom box 40 of FIG. 1, and electrical contact 30 may engage the second conducting electrode 2b in a region designated by phantom box 42, but again, this is not required.

FIG. 4 is similar to FIG. 3, except that electrical contact 28 does not extend out further from the insertion end 12 of the test strip relative to electrical contact 30, but rather extend out substantially coextensively. When so provided, electrical contact 28 may engage the first conducting electrode 2a in a region designated by phantom box 40 shown in FIG. 1, and electrical contact 30 may engage the second conducting electrode 2b in a region designated by phantom box 44.

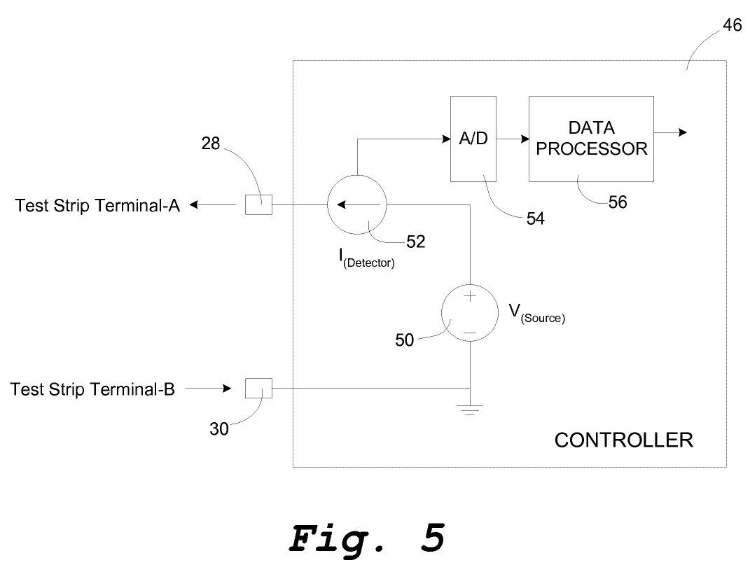

FIG. 5 is a schematic diagram of an illustrative controller of FIGS. 3-4. The illustrative controller 46 includes a voltage source 50 that provides a known voltage across electrical contacts 28 and 30. The voltage source 50 may provide a DC voltage and/or an AC voltage, depending on the application. In the illustrative embodiment, a current sensor 52 is provided between the voltage source 50 and one of the electrical contacts, or in the case shown, between the voltage source 50 and electrical contact 28. In the illustrative embodiment, the current sensor 52 provides an analog signal that is related to the current sensed to an Analog-to-Digital (A/D) Converter 54. The A/D converter 54 converts the analog signal to a digital value, and passes the digital value to a data processor 56. Using the digital value, the data processor 56 may calculate or otherwise determine a value that is related to a desired parameter of the analyte. In some cases, the controller 46 may measure the resistance between the first and second conducting electrodes 2a and 2b of the test strip, which includes the blood sample in sensing area 8 (see FIG. 1). However, the controller 46 may have any suitable configuration for measuring any suitable electrical characteristic of the test strip, depending on the application and the analyte of interest.

FIG. 6 is a schematic top view of an illustrative test strip 60 that is inserted into a monitor device. In this illustrative embodiment, the insertion end 12 of the test strip 60 is shaped to be keyed with the stop 62 of the monitoring device. The insertion end 12 of the illustrative test strip 60 includes a first portion 64 that extends our further (toward the stop) than a second portion 66. The stop 62 of the monitoring device is shaped to have a mating shape as the insertion end 12 of the test strip 60. That is, the insertion end 12 and the stop 62 may be shaped so that they are keyed relative one another.

In the illustrative embodiment, the second electrode 2b extends out past (toward the stop) the second portion 66 of the insertion end 12 of the test strip 60. Although not required, a first electrical contact 28 may engage the first conducting electrode 2a in a region designated by phantom box 68, and the second electrical contact 30 may engage the second conducting electrode 2b in a region designated by phantom box 70, but this is also not required.

In some cases, a thinner part of the insertion end 12 of the test strip 60 may extend into region 72, but that a change in thickness of the insertion end 12 of the test strip 60 may be provided at the second portion 66. The stop 62 may then be shaped to be keyed to the thickness change of the test strip 60. That is, in some cases, the thickness of the insertion end 12 of the test strip 60 may be used to key the test strip 60 to the stop 62. In some cases, both the overall outer perimeter of the insertion end 12 of the test strip 60 as well as the thickness topology of the insertion end 12 may be used to key to the test strip to the stop 62 of the monitoring device. Using one or more such features at the insertion end of the test strip to key the test strip to the stop of the monitoring device may help prevent users from inserting improper test strips into the monitoring device, and/or proper test strips in an improper orientation or manner.

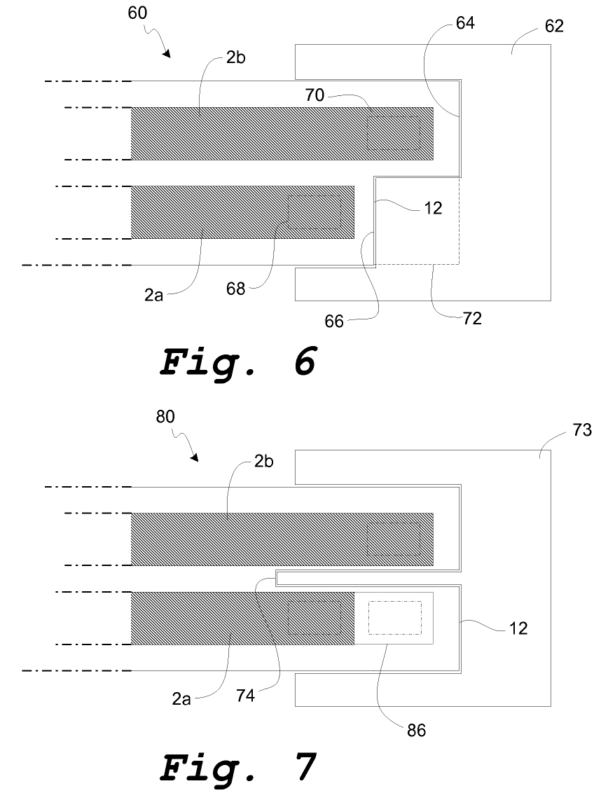

FIG. 7 is a schematic top view of yet another illustrative test strip 70 that is inserted into a monitor device. In this illustrative embodiment, the insertion end 12 of the test strip 70 is shaped to be keyed with the stop 73 of the monitoring device. The insertion end 12 of the illustrative test strip 70 includes a slot 74 that extends a distance from the insertion end 12 of the test strip 70 toward the sensing end 14. The slot 74 may extend all the way through the test strip 80 resulting in through slot, or may only extend partially through the test strip 80 resulting in a thinned portion of the test strip 80.

In the illustrative embodiment, the stop 73 of the monitoring device is shaped to have a mating shape as the insertion end 12 of the test strip 80. That is, the insertion end 12 and the stop 73 are shaped to be keyed relative one another. In the illustrative embodiment, the second conducting electrode 2b extends closer to the insertion end 12 of the test strip 80 than the first conducting electrode 2a, but this is not required as illustrated by dashed lines 86. Also, and in the illustrative embodiment, the slot 74 may extend between the first and second conducting electrodes 2a and 2b, but this is also not required.

In some cases, it is desirable to provide one or more information and calibration data relative to the test strip to the monitoring device. Identification codes may be used to identify the particular analyte the test strip it intended to measure, the manufacturer and/or batch or lot of the test strip, an expiration date, a model of meter to be used, and/or any other suitable information, as desired. In some cases, if the monitoring device detects that the test strip is not appropriate for the monitoring device, the monitoring device may reject the test strip, and not provide results. Calibration data may provide calibration parameters to be used by the meter in measuring analyte concentration using the test strip. Calibration parameters may include, for example, temperature, time, current measurements to be made, reference standards, offsets, algorithms for calculating the analyte concentration or an average of analyte concentration over a period of time, etc.

It is contemplated that some or all of the desired identification codes and/or calibration data may be stored on the test strip itself. For example, it is contemplated that some or all of the desired identification codes and/or calibration data may be stored in a bar code printed or otherwise provided on the test strip, an RF tag on or in the test strip, a magnetic strip on or in the test strip, an optical storage medium on or in the test strip, an optical pattern on or in the test strip (see, for example, FIGS. 10-12 below), and/or any other suitable storage or indicating element or device.

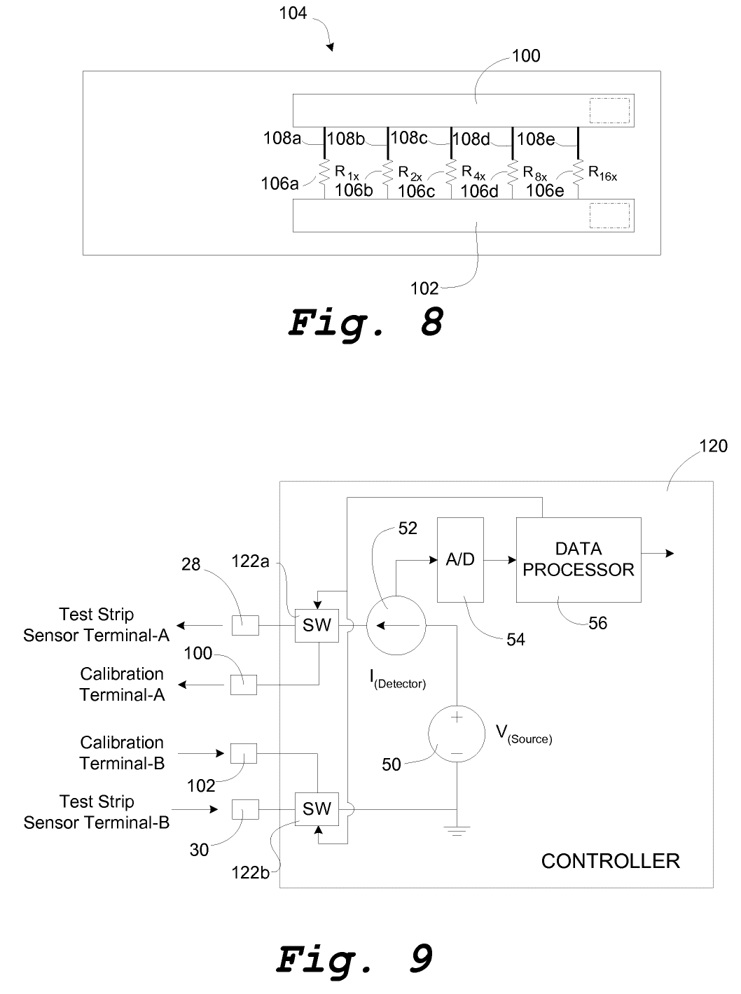

In some cases, some or all of the desired identification codes and/or calibration data may be stored in a programmable impedance circuit. FIG. 8 shows one illustrative programmable impedance circuit that may be applied to a test strip for storing identification and/or calibration data. During use, the monitoring device may measure the impedance of the programmable impedance circuit and determine therefrom one or more identification codes or calibration data codes for use with the test strip.

In the illustrative embodiment shown in FIG. 8, a first electrode 100 and a second electrode 102 are provided on a test strip 104. In some cases, the first electrode 100 and the second electrode 102 may be provided on the back side of the test strip, such as the back side of the test strip of FIG. 1. The illustrative programmable impedance circuit includes a number of resistors 106a-106e, as shown. In some cases, the resistors 106a-106e may have different resistance values, such as 1X, 2X, 4X, 8X and 16X, where “X” represents a base resistance value. It is contemplated that the first electrode 100, the second electrode 102 and the resistors 106a-106e may be deposited on the test strip 104 by a conventional printing process, e.g. thick film printing (also known as screen printing), lithography, letterpress printing, vapor deposition, spray coating, ink jet printing, laser jet printing, roller coating or vacuum deposition, to name a few.

To program the programmable impedance circuit, and preferably during manufacture and/or testing of the test strip 104, selected conducting traces 108a-108e may be provided, while others may not. These conducting traces 108a-108e may thus selectively include or exclude their corresponding resistor 106a-106e from the programmable impedance circuit. The conducting traces 108a-108e may be deposited on the test strip 104 by a conventional printing process, e.g. thick film printing (also known as screen printing), lithography, letterpress printing, vapor deposition, spray coating, ink jet printing, laser jet printing, roller coating or vacuum deposition, to name a few.

Alternatively, the conducting traces 108a-108e may be configured as fuses, which can be selectively blown by laser ablation any other suitable mechanism, thereby either selectively including or excluding their corresponding resistor 106a-106e in the programmable impedance circuit. In yet another alternative embodiment, the resistors 106a-106e themselves may either be provided or not provided on a particular test strip 104. In any case, a number of unique resistance values can be programmed by including or excluding certain combination of resistors from the programmable impedance circuit. A controller, which reads the resistance value of the programmable impedance circuit, may then correlate each unique resistance value to one or more information and/or calibration codes, which can then be used to service/calibrate the corresponding test strip 104.

FIG. 9 is a schematic diagram of an illustrative controller 120 that may be used in conjunction with the test strip 104 of FIG. 8. This controller 120 is similar to that shown and described with reference to 5. However, switches 122a and 122b are now added. In some cases, and after the test strip 104 is inserted into the monitoring device, the data processor 56 may control the switches 22a-22b so that the voltage source 50 provides a controlled voltage to electrodes 100 and 102 of FIG. 8. The current sensor 52 may then sense the impendence of the programmable resistor network 106a-106e. Depending on which resistors 106a-106e are programmed into the circuit, a unique resistance value will be provided, which will cause a unique current value to be sensed by current sensor 52. The current sensor 52 then provides a measure related to the unique current value to A/D converter 54, which provides a corresponding digital value to data processor 56. Data processor 56 may then use the digital value to determine one or more information or calibration codes or parameters. This may be accomplished in any number of ways, but may be performed by using the digital value provided by the A/D converter 54 as an address into a look-up table stored in data processor 56. The lookup table may provide one or more information and/or calibration parameters that can be used in conjunction with the particular test strip to, for example, calculate a more accurate analyte concentration.

The data processor 52 may also control the switches 22a-22b so that the voltage source 50 provides a controlled voltage to electrodes 28 and 30 of, for example, FIGS. 3-4. The voltage source 50 may then provide a controlled voltage to the electrical contacts 28 and 30, and a current sensor 52 may provides an analog signal that is related to the sensed current to an Analog-to-Digital (A/D) Converter 54. The A/D converter 54 converts the analog signal to a digital value, and passes the digital value to a data processor 56. Using the digital value provided by the A/D converter 54, along with one or more of the information and/or calibration parameters, the data processor 56 calculates or otherwise determines a value that is related to a desired parameter of the analyte. In some cases, the controller 120 measures the resistance between the first and second conducting electrodes 2a and 2b of the test strip, which includes the blood sample in sensing area 8 (see FIG. 1). However, it is contemplated that the controller 46 may have any suitable configuration for measuring any suitable electrical characteristic of the test strip, depending on the application and the analyte of interest.

While a simple parallel resistor network is provided as an example programmable impedance circuit, it should be recognized that other circuits may also be used. For example, it is contemplated that inductors, capacitors, transistors and/or other elements may be used in a programmable impedance circuit. For example, one or more resistors, capacitors and/or inductors may be selectively programmed to provide one or more AC filters. The detected poles of the filter(s) may then be used to correlate to one or more information or calibration parameters, as desired.

FIG. 10 is a top view of an illustrative test strip positioned in a monitoring device in accordance with another illustrative embodiment of the present invention. In the illustrative embodiment shown in FIG. 10, the monitoring device includes a number of photodetectors such as photodiodes 140a-140f positioned adjacent to the test strip 14, and the test strip 14 has a programmable pattern of apertures 142a-142c. In the illustrative embodiment, the photodiodes 140a-140f are positioned adjacent to (e.g. below or above) the test strip 14, and when the test strip 14 is inserted into the monitoring device, the photodiodes 140a-140f align with corresponding apertures 142a-142c in the test strip 14.

In FIG. 10, the photodiodes 140a-140f are shown as boxes, and the apertures 142a-142c are shown as circles. The photodiodes 140b, 140d and 140e that can be seen through the apertures 142a-142c are shown in solid lines, while the photodiodes 140a, 140c and 140f that cannot be seen through an aperture (i.e. do not have a corresponding aperture) are shown in dashed lines. In FIG. 10, a linear array of six photodiodes 140a-140f are shown, and the test strip 14 includes a programmed pattern of three apertures 142a-142c.

During use, a controller (not explicitly shown in FIG. 10) coupled to the photodiodes 140a-140f of the monitoring device may be used to detect the particular pattern of apertures 142a-142c provided in the test strip 14, and from the detected pattern, may decode or otherwise determine identification and/or calibration data for the test strip 14.

It is contemplated that the photodiodes 140a-140f may be provided in a one or two dimensional array on the monitoring device, or in any other suitable arrangement, and the test strip 14 may include apertures that correspond to only some of the photodiodes 140a-140f. While six photodiodes 140a-140f and three apertures 142a-142c are shown in FIG. 10, it is contemplated that any suitable number of photodiodes and/or apertures may be used, depending on the application. In addition, while the test strip 14 shown in FIG. 10 is similar to that shown in FIG. 1, it is contemplated that the test strip may take on any suitable form or configuration, depending on the application.

FIG. 10 also shows, generally at 146, a two-dimensional array of photodiodes, with a two-dimensional programmable pattern of apertures. The photodiodes and pattern of apertures generally shown at 146 may be provided in addition to, or in place of, the photodiodes 140a-140f discussed above. Like above, and during use, a controller (not explicitly shown in FIG. 10) may be coupled to the photodiodes generally shown at 146, and may detect the particular pattern of apertures in the test strip 14, and from the detected pattern, may decode or otherwise determine identification and/or calibration data for the test strip 14.

In some cases, a dedicated photodiode and aperture may be used to detect the insertion position of the test strip within the monitoring device. That is, it is contemplated that a photodiode and corresponding aperture, generally shown at 148, may be provided, such that when the test strip is inserted into the monitoring device an appropriate amount, the aperture and photodiode align as shown at 148. A controller coupled to the photodiode may detect when the test strip is positioned appropriately in the monitoring device, and may then initiate a reading of the test strip. The controller may monitor the photodiode while reading the test strip, and if the test strip is moved out of position during the reading process, the results may be invalidated. Rather than providing a separate or dedicated photodiode and aperture for detecting the insertion position of the test strip, it is contemplated that, in some cases, one or more of the photodiodes 140a-140f, apertures 142a-142c, and/or photodiodes/apertures 146, may be used to detect the insertion position of the test strip, as desired.

Instead of, or in addition to providing apertures through the test strip, it is contemplated that a pattern of reflecting surfaces may be provided on the test strip. In such a case, an array of photo-emitter/photo diode pairs may be provided on or in the monitoring device. When so provided, a photo-emitter (e.g. LED) may emit a beam of light toward the test strip, and if the test strip has a reflector adjacent to the photo-emitter, some of the emitted light beam will be reflected back to a corresponding photo diode. If no reflector is provided adjacent to the photo-emitter, an insufficient quantity of light may be reflected back to the corresponding photo diode (e.g. below a threshold amount). During use, a controller (not explicitly shown in FIG. 10) may be coupled to the photo-emitter/photodiode pairs, and may detect the particular pattern of reflectors on the test strip 14, and from the detected pattern, may decode or otherwise determine identification and/or calibration data for the test strip 14.

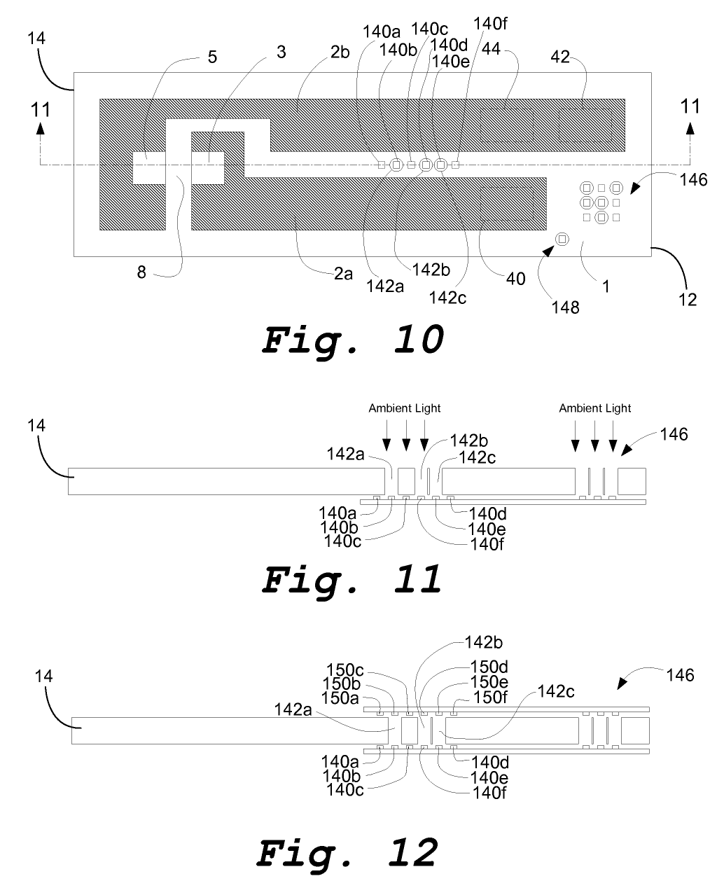

FIG. 11 is a schematic cross-sectional side view of an illustrative embodiment of the test strip and monitoring device of FIG. 10 taken along line 11-11. In this illustrative embodiment, the photodiodes 140a-140e are positioned below the test strip 14, and are adapted to detect ambient light that travels through the apertures 142a-142c. When an aperture is positioned directly above a photodiode, that photodiode may detect ambient light passing through the aperture. When an aperture is not provided above a photodiode, the test strip may function to block sufficient ambient light from reaching the photodiode. While some ambient light may still be detected by a photodiode that does not have a corresponding aperture, the amount of light may be significantly reduced, and the controller may still reliably determine when a corresponding aperture is present or not in the test strip.

FIG. 12 is a schematic cross-sectional side view of another illustrative embodiment of the test strip and monitoring device of FIG. 10 taken along line 11-11. In this illustrative embodiment, photodiodes 140a-140f are positioned below the test strip 14, and a corresponding set of photo emitters (e.g. LEDs) 150a-150f are positioned above the test strip. The terms below and above are used herein only in a relative sense, and not necessarily with respect to gravity. The illustrative embodiment of FIG. 12 operates similar to that described above with respect to FIG. 11, but does not rely on ambient light. Instead, photo emitters 150a-150f each provide a light beam toward the test strip, and if a corresponding aperture is present, the emitted light will reach the corresponding photodiode, and if a corresponding aperture is not present, the emitted light will not reach the corresponding photodiode.

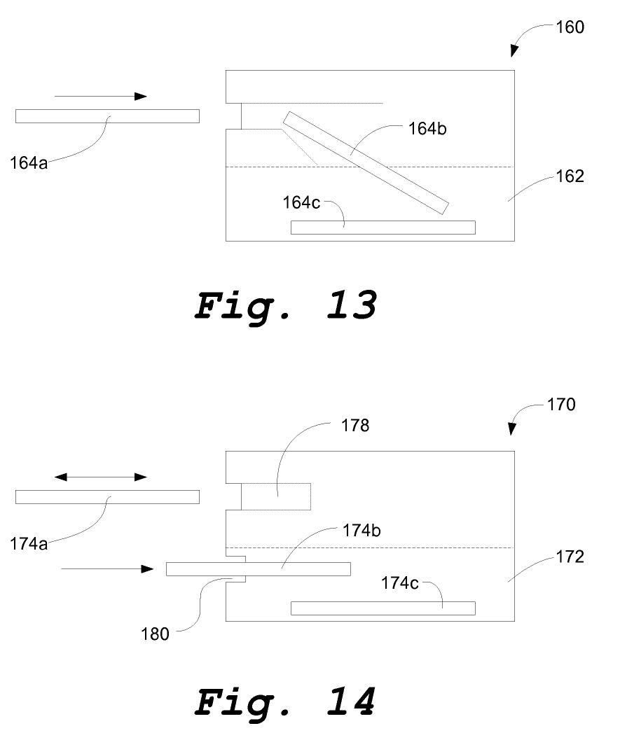

FIG. 13 is a schematic view of an illustrative monitoring device 160 that includes a sharps container 162. The Sharps container 162 may be any suitable container that can safely store used test strips, such as test strips 164a, 164b and 164c. In the illustrative embodiment, the Sharps container 162 is removably secured to the monitoring device. When the Sharps container is sufficiently full of used test strips, the user may remove the Sharps container 162 from the monitoring device, and dispose thereof. A new Sharps container may then be secured to the monitoring device.

In the illustrative embodiment, the monitoring device receives a test strip via slot 166. The test strip is then read by the monitoring device. The user then pushes the test strip further into the monitoring device, as shown by test strip 164b, until the test strip is guided or otherwise falls into the Sharps container 162, as shown by test strip 164c. In some cases, the Sharps container 162, or parts thereof, may be at least partially transparent so the user can see how full the Sharps container 162 has become. Once the Sharps container 162 is sufficiently full, the user may remove the Sharps container 162 from the monitoring device, and properly dispose thereof. A new Sharps container 162 may then be installed for future use.

FIG. 14 is a schematic view of another illustrative monitoring device 170 with a sharps container 172. The Sharps container 172 may be any suitable container that can safely contain used test strips, such as test strips 174a, 174b and 174c. As in FIG. 13, the Sharps container 172 may be removably secured to the monitoring device.

During use, a test strip, such as test strip 174a may be inserted into a slot 178 of the monitoring device. Once the monitoring device reads the test strip, the user may withdraw the test strip 174a from the monitoring device. The user may then insert the test strip into a slot 180 of the Sharps container 172, as shown by test strip 174b, until the test strip is guided or otherwise falls into the Sharps container 172, as shown by test strip 174c.

Having thus described several embodiments of the present invention, those of skill in the art will readily appreciate that other embodiments may be made and used which fall within the scope of the claims attached hereto. It will be understood that this disclosure is, in many respects, only illustrative. Changes can be made with respect to various elements described herein without exceeding the scope of the invention.

What is claimed is:

1. A test strip for electrochemical analysis of an analyte, comprising:
a substrate having an insertion end for insertion into a monitoring device;
a first conducting electrode on the substrate;
a second conducting electrode on the substrate;
a sensing region situated between the first conducting electrode and the second conducting electrode;
the first conducting electrode extending a first distance from the insertion end of the substrate;
the second conducting electrode extending a second distance from the insertion end of the substrate, wherein the second distance is greater than the first distance.

2. The test strip of claim 1 wherein the second distance is greater than the first distance by at least 1 mm.

3. The test strip of claim 1 wherein the second distance is greater than the first distance by at least 2 mm.

4. The test strip of claim 1 wherein the second distance is greater than the first distance by at least 2.5 mm.

5. A system for the electrochemical analysis of an analyte in a fluid sample comprising:
a test strip having an insertion end and an opposite sensing end, the test strip further having a first conducting electrode and a second conducting electrode, wherein the first conducting electrode extends a first distance from the insertion end of the test strip and the second conducting electrode extending a second distance from the insertion end of the test strip, wherein the second distance is greater than the first distance; and
a monitor having an slot with a stop configured for receiving and positioning the test strip in the monitor, the monitor having first and second electrical contacts, wherein the first and second electrical contacts are configured to contact the first and second conducting electrodes when a test strip is inserted into the opening of the monitor.

6. The system of claim 5, wherein the first electrical contact extends out further toward the sensing end of the test strip than the second electrical contact.

7. The system of claim 5, wherein the first electrical contact extends out substantially the same distance toward the sensing end of the test strip than the second electrical contact.

8. A test strip for electrochemical analysis of an analyte, comprising:
a substrate having an insertion end for insertion into a monitoring device;
a first conducting electrode on the substrate;
a second conducting electrode on the substrate;
a sensing region situated between the first conducting electrode and the second conducting electrode; and
at least part of the insertion end of the test strip having a first portion and a second portion, wherein the first portion extends out past the second portion.

9. The test strip of claim 8 wherein the perimeter of the insertion end of the test strip defines the first portion and the second portion.

10. The test strip of claim 8 wherein a thickness of the insertion end of the test strip defines the first portion and the second portion.

11. The test strip of claim 8 further comprising a monitoring device, wherein the monitoring device includes a stop that is keyed to the insertion end of the test strip.

12. A test strip for electrochemical analysis of an analyte, comprising:
a substrate having an insertion end for insertion into a monitoring device;
a first conducting electrode on the substrate;
a second conducting electrode on the substrate;
a sensing region situated between the first conducting electrode and the second conducting electrode; and
a slot extending from the insertion end of the test strip toward the sending end.

13. The test strip of claim 11 wherein the slot extends all the way through the test strip.

14. The test strip of claim 11 wherein the slot extends only partially through the test strip.

15. A system for the electrochemical analysis of an analyte in a fluid sample comprising:
a monitoring device having a stop; and
a test strip having an insertion end for insertion into a monitoring device and for rest against the stop, the insertion end of the test strip having one or more features that are keyed to the stop of the monitoring device.

16. A test strip for electrochemical analysis of an analyte, comprising:
a substrate; and
a programmable impedance circuit on or in the substrate.

17. The test strip of claim 15 wherein the programmable impedance circuit includes two or more resistors that can be programmed into and/or out of the programmable impedance circuit.

18. The test strip of claim 15 wherein the programmable impedance circuit is adapted to be programmed during manufacture of the test strip.

19. A test strip for electrochemical analysis of an analyte, comprising:
a substrate;
a first conductive electrode and a second conductive electrode held by the substrate;
a reagent layer deposited on a portion of the first conducting electrode, the reagent layer containing one or more analyte-specific reagents; and
a programmable memory secured relative to the substrate for storing one or more information and or calibration data that corresponds to the test strip.

20. A system for perform an electrochemical analysis of an analyte, comprising:
a monitoring device for receiving a test strip, the monitoring device and test strip adapted to perform an electrochemical analysis of an analyte placed on the test strip by a user; and
a Sharps container removably attached to the monitoring device, the Sharps container having an opening for receiving used test strips.

21. The system of claim 19, wherein the Sharps container is adapted to be disposable.

22. The system of claim 20, wherein the Sharps container is adapted to retain the used test strips after the Sharps container is removed from the monitoring device.
